(19) United States
(12) Patent Application Publication
(10) Pub. No.: US 2006/0245859 A1
(43) Pub. Date: Nov. 2, 2006

(54) Multi-level storage structure

(76) Inventors: Dion Stuart Frank, Claremont (ZA); Maurice Segal, Jerusalem (IL)

Correspondence Address: DALINA LAW GROUP, P.C., 7910 IVANHOE AVE. #325, LA JOLLA, CA, 92037, US

(21) Appl. No.: 11/442,629

(22) Filed: May 25, 2006

(30) Foreign Application Priority Data
Sep. 23, 2004 (WO) PCT/ZA04/00116
Dec. 19, 2003 (ZA) 2003/9839
Sep. 25, 2003 (ZA) 2003/7428

(51) Int. Cl. B65G 65/00

(52) U.S. Cl. 414/277

(57) ABSTRACT

Storage structures are disclosed in which lifts carry articles to be stored, such as motor vehicles to be parked, from entry level to storage levels. Each lift comprises sets of endless elements such as chains which carry platforms. Each platform is permanently attached to one set of endless elements. Each platform is releasably attached to the other set of endless elements whilst that platform is in the operative run of the lift and is horizontal. When the platform is in the inoperative run of the lift it is vertical. Rotatable rings or reciprocating shuttles, with bays for temporarily accommodating articles, move the articles between the lifts and storage bays provided at each storage level.

### BACKGROUND OF THE INVENTION

1. Field of the Invention

This invention relates to multi-level storage structures and specifically, but not exclusively, to parking garages.

2. Description of the Related Art

The space required within which vehicles can be parked conventionally comprises the parking bay itself which must be of sufficient width to enable vehicle doors to be opened, access ramps to enable vehicles to be driven to the bays and pedestrian access to the bays. The overall result is waste of space.

If an automated parking system is used, the pedestrian access and driveways for the vehicles can be omitted and space is saved.

An object of the invention is substantially to decrease the time taken to park and retrieve a vehicle, which in existing automatic systems is long relative to the time required to drive into and park in a ramped parking garage. This relative slowness has made automated parking garages unpopular with the users who are forced to wait for the vehicles to be delivered to them, especially at rush hours. The problems of slow delivery are in some instances due to the time taken to deliver vehicles by an insufficient number of lifts.

Applicants are aware of the following disclosures of automatic parking garages:

| | |
|---|---|
| U.S. Pat. No. 5469676 | U.S. Pat. No. 6004091 |
| U.S. Pat. No. 5674040 | U.S. Pat. No. 5478182 |
| U.S. Pat. No. 4039089 | U.S. Pat. No. 5024573 |
| U.S. Pat. No. 5915908 | U.S. Pat. No. 5851098 |
| Swiss 684203 | EP 445712 |
| Japan 449377 | Japan 63222406 |

Another object of the present invention is to provide a parking structure which is an improvement over those described in the specifications listed above.

### BRIEF SUMMARY OF THE INVENTION

According to one aspect of the present invention there is provided a lift for a storage system, the lift comprising two sets of endless elements with load supporting platforms attached thereto at intervals, the lift having an operative run in which the platforms are horizontal and can support a load and an inoperative run in which the platforms are upright, the platforms being permanently connected to one set of endless elements and detachably connected to the other set of endless elements, and means at the upper and lower ends of the lift for displacing said platforms between a horizontal, operative position in which they are connected to both of said sets of elements and an inoperative, upright position in which they are connected to one of said sets of elements only.

Each platform can comprise a series of parallel spaced bars each of which is supported at one end only thereby to form a comb. Preferably each platform comprises two series of parallel bars, the bars of each series being supported at one end only thereby to form two combs, the free ends of the bars of the two combs facing one another across a gap.

Said one set of elements comprises a first pair of endless elements, the endless elements of the first pair being entrained around first pairs of upper wheels rotatable about a first common axis and the lower wheels being rotatable about a second common axis parallel to said first common axis, there being means for driving the upper or lower pairs of wheels and said platforms being pivotally and permanently connected to said first pair of endless elements, the other set of endless elements comprising a second pair of endless elements, the elements of the second pair being entrained around second pairs of upper and lower wheels, the upper wheels of the second pair being rotatable about a common third axis and the lower wheels of the second pair being rotatable about a common fourth axis, the third and fourth axes being parallel to one another, and there being means for releasably attaching the platforms to the second pair of endless elements whilst the platforms are in the operative horizontal positions thereof.

According to a further aspect of the present invention there is provided a storage structure comprising:
at entry and exit level, a rotatable transfer ring including bays, each bay having means for supporting an article to be stored and transport means for transferring articles between positions radially outwardly of said ring and positions within the bays, and between positions within the bays and positions radially inwardly of said ring; and
at each storage level a rotatable inner ring including bays, each bay having means for supporting an article to be stored and there being transport means for transferring articles between positions radially outwardly of said inner ring and positions within the bays, and between positions within the bays and positions radially inwardly of said inner ring, and a stationary outer ring having bays for storing articles; and
at least two lifts radially inwardly of the rotatable transfer and inner rings for conveying articles between said entry and exit level and said storage level(s).

Each bay of the outer ring at a storage level preferably has a floor comprising a fixed comb of parallel bars supported at one end. Each bay of the rotatable ring at a storage level can comprise a fixed comb of parallel bars and a movable comb of parallel bars, the bars of the movable comb being able to pass through gaps between the bars of the fixed comb.

To facilitate entry and exit, turntables are provided at the entry and exit level to enable the article to be stored to be aligned with the bays of the rotatable transfer ring.

According to another aspect of the present invention there is provided a storage structure comprising a plurality of storage levels, there being lifts for bringing articles to the storage levels and removing articles from the storage levels, the structure further comprising, at each storage level, a reciprocable shuttle having bays for temporarily accommodating articles to be stored, storage bays for receiving articles to be stored, and means carried by the shuttle for transferring articles between the lifts and the shuttle and between the bays and the shuttle.

The storage structure can include turntables at an entry and exit level, each of the turntables being rotatable between a loading position and a position aligned with a lift for transfer of an article between the turntable and lift.

Preferably the turntables have a third position for unloading.

In the preferred construction, each lift comprises two sets of endless elements with load supporting platforms attached thereto at intervals, each lift having an operative run in which the platforms are horizontal and can support a load and an inoperative run in which the platforms are upright, the platforms being permanently connected to one set of endless elements and detachably connected to the other set of endless elements, and means at the upper and lower ends of the lift for displacing said platforms between a horizontal, operative position in which they are connected to both of said sets of elements and an inoperative, upright position in which they are connected to one of said sets of elements only.

Said one set of endless elements of each lift can comprise a first pair of endless elements, the endless elements of the first pair being entrained around first pairs of upper wheels rotatable about a first common axis and the lower wheels being rotatable about a second common axis parallel to said first common axis, there being means for driving the upper or lower pairs of wheels and said platforms being pivotally and permanently connected to said first pair of endless elements, the other set of endless elements of each lift comprising a second pair of endless elements, the elements of the second pair being entrained around second pairs of upper and lower wheels, the upper wheels of the second pair rotatable about a common third axis and the lower wheels of the second pair rotating about a common fourth axis, the third and fourth axes being parallel to one another, and there being means for releasably attaching the platforms to the second pair of endless elements whilst the platforms are in the operative horizontal positions thereof.

### BRIEF DESCRIPTION OF THE DRAWINGS

For a better understanding of the present invention, and to show how the same may be carried into effect, reference will now be made, by way of example, to the accompanying drawings in which:

FIG. 1 is a diagrammatic top plan view of the entry and exit level of a vehicle parking garage;

FIG. 2 is a diagrammatic top plan view of a parking level;

FIG. 3 is a detail of a vehicle supporting structure;

FIG. 4 is a top plan view of a vehicle lift;

FIG. 5 is a side elevation of a vehicle lift;

FIG. 6 is a plan view of a modified entry and exit level.

FIG. 7 is a diagrammatic top plan view of the entry and exit level of a further vehicle parking garage;

FIG. 8 is a diagrammatic top plan view of a parking level of the garage of FIG. 7;

FIG. 9 is a diagrammatic top plan view of the entry and exit level of another vehicle parking garage;

FIG. 10 is a diagrammatic top plan view of a parking level of the garage of FIG. 9; and

FIGS. 11 and 12 illustrate another form of parking garage.

### DETAILED DESCRIPTION

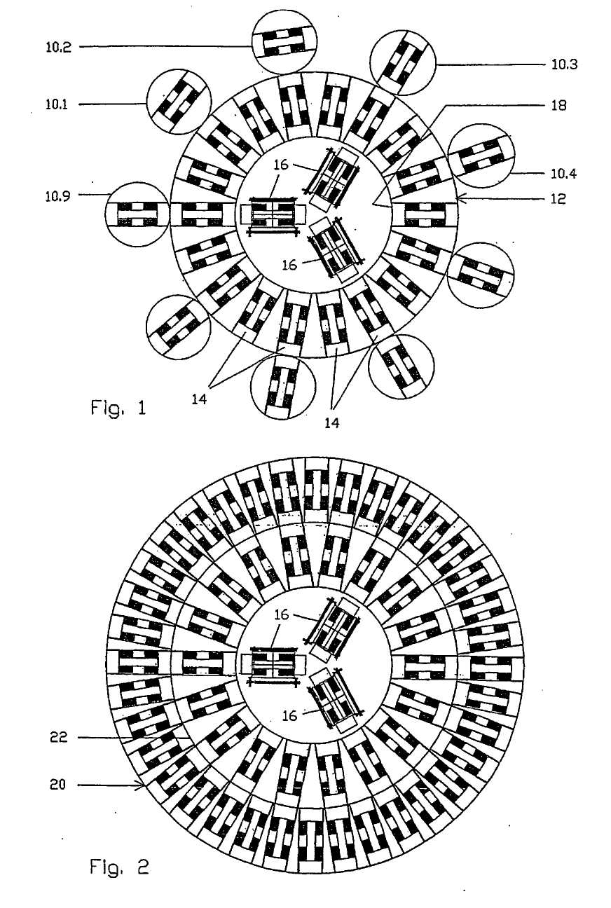

Referring firstly to FIG. 1, the vehicle parking garage is constructed on a circular format and includes entry and exit turntables. In the illustrated embodiment there are nine equally spaced turntables designated 10.1, 10.2 etc. Turntables 10.1 and 10.2 are shown in the position they adopt whilst a vehicle is being driven on or driven off. Turntables 10.3 to 10.9 are shown in the position they adopt to enable a vehicle to be transferred between a turntable and a rotatable transfer ring 12 which lies radially inwardly of the turntables 10.1, 10.2 etc. The ring 12 has eighteen bays designated 14.

Three vehicle lifts (or elevators) 16 are provided within a central shaft 18 which is encircled by the transfer ring 12. The term Alifts@ is used for the sake of convenience but it will be appreciated that these simply comprise platforms moving on conveyor chains.

In FIG. 2, which shows the floor layout from the first floor upwards, there is a stationary outer structure 20 which, in the illustrated embodiment, provides parking for vehicles in a radial position. Inwardly of the structure 20 there is a rotating transfer ring 22. The lifts 16 are also shown in FIG. 2.

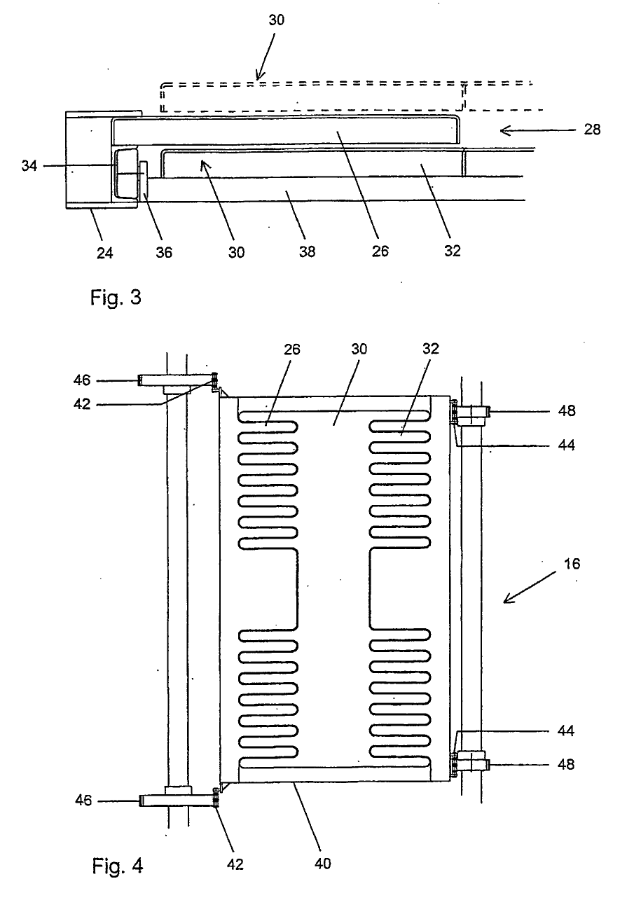

The structure shown in FIG. 3 comprises an end support 24 from which a series of parallel spaced bars 26 protrude. The bars 26 are supported at one end only and thus form a fixed comb designated 28. A movable comb 30 is also shown, this consisting of a series of parallel bars 32. The movable comb 30 can be displaced up and down so that the bars 32 pass through the gaps between the bars 26. Drive means (not shown) for moving the comb 30 in forward and backward movements and in up and down movements are provided. In FIG. 3 the movable comb 30 is shown twice. More specifically it is shown in full lines below the fixed comb 28 and in dotted lines above the fixed comb 28. A wheel 34 is shown which runs on the end support 24. A support 36 is carried by the wheel 34 and a carriage 38 is in turn carried by the support 36. The structure illustrated is repeated on the other side of the carriage so that both sides of the carriage are supported by pairs of wheels 34. This permits the carriage to move backwards and forwards carrying the comb 30 with it. The comb 30 can, as described, be raised and lowered with respect to the carriage 38.

At entry level the floor of each turntable 10.1, 10.2 etc, comprises a fixed comb 28 and a movable comb 30. There are in addition three movable combs 30 aligned with the lifts and located in pits at a level below the fixed combs 28 of the bays 14. These combs move vehicles between the ring 12 and fixed combs 28 in the lifts 16.

The lifts 16 have floors consisting of fixed combs 28.

At each parking level each vehicle bay in the outer ring 20 has a floor consisting of a fixed comb 28. Each bay of the transfer ring 22 has a floor comprising a movable comb 30 and a fixed comb 28.

To avoid the use of more material than is required, each comb can comprise sets of bars arranged where the wheels of a vehicle will be positioned. Thus, in FIG. 4, the fixed comb comprises four sets of bars 32 linked together to form the comb. This construction is possible everywhere except insofar as the turntables are concerned which is the only place where the vehicles being parked or retrieved are driven. A support covering the full area of the turntable is thus required. This is accomplished by the movable combs 30 being kept at a central height level with the fixed combs 28 so as to maintain a level surface for the vehicles to be driven onto and to stand on.

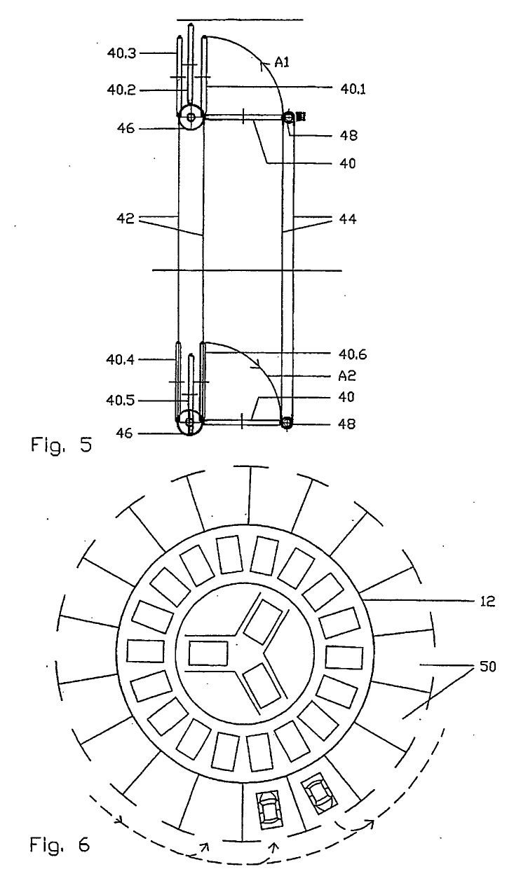

The fixed comb 28 of each lift 16 forms part of a platform 40 (FIGS. 4 and 5) which is secured to pairs of chains 42, 44 which are driven by pairs of upper and lower wheels in the form of chain sprockets 46, 48. The sprockets 46, 48 are linked together by further chains to ensure that the chains 42, 44 move in unison. The left hand edge of the platform 40 can pivot with respect to the chains 42 but cannot be detached therefrom. The mountings for the left hand side of the platform 40 comprise short spigots which enable the platforms to swing over, as will be described, without interference. The right hand edge of the platform 40 is supported by the chains 44 but can be detached therefrom. Chains are preferred but other endless elements such as toothed belts entrained around toothed wheels can be used.

Referring now to FIG. 5, this shows the upper and lower ends of the vertical extent of one of the lifts. This thus illustrates entry level (FIG. 1) and the top parking floor.

Upon the platform 40 at the upper parking level starting to move beyond that level, a hydraulic or pneumatic cylinder, or a mechanical device, moves the top platform 40 to the position shown at 40.1. This position is preferably upright, but in this context upright also covers a small angle of inclination to vertical. This movement is indicated by the arrow A1. As the top sprocket 46 turns anticlockwise, the platform 40 moves from the position 40.1 through the position 40.2 to the position 40.3. It is retained in this vertical position whilst it is in the inoperative return run of the lift. This is the left hand run in FIG. 5. As the platform reaches the lower sprocket 46 it is moved from the position 40.4, which it is in when it reaches the lower sprocket 46, through the position 40.5 to the position 40.6 from which it is swung down, as shown by the arrow A2, so that its right hand edge is re-supported by the chains 44.

This arrangement ensures that the unused return run takes up as little space as possible in the centre shaft.

It will be understood that the chains 42, 44 can be driven in either direction, and that the spacing between the platforms 40 equals the spacing between floors.

In use, a vehicle is driven onto a turntable whilst it is as shown at 10.1, 10.2. Once the driver and any passengers have parked the vehicle and departed, doors (not shown) to the turntable area are closed and the turntable rotates to the position shown at 10.3, 10.4 etc.

After appropriate rotation of the transfer ring 12, the movable comb 30 under the turntable moves to its upper position, its bars passing between the bars of the fixed comb 28 of the turntable and lifting the vehicle off the fixed comb 28 of the turntable. The movable comb 30 then moves radially inwardly with its carriage 28 so that the vehicle is now in one of the bays 14 of the transfer ring 12. The movable comb 30 then drops to its lower position and returns to its station under the fixed comb 28 of the turntable. It then rises so that it is level with the fixed comb 28 of the turntable. At the same time the ring 12 rotates until the vehicle is aligned with one of the lifts 16. The movable comb 30 associated with that lift is raised to above the level of the fixed comb 28 of the bay 14 which is aligned with the lift 16. The movable comb 30 lifts the vehicle off the fixed comb 28 of the transfer bay 14 and deposits it onto one of the platforms 40 of the lift 16. After comb 30 has been lowered, the carriage returns to its station under a transfer bay. The lift 16 then raises or lowers the vehicle to the designated floor.

At the designated floor that one of the movable combs of the transfer ring 22, which is aligned with the lift 16, moves radially inwardly and then upwardly to lift the vehicle off the fixed comb of the platform 40. The movable comb moves radially outwardly and downwards, and the inner ring 22 is subsequently rotated, with the vehicle supported on the fixed comb of the respective bay, until it is aligned with the designated bay of the outer ring 20. The movable comb is then raised to its upper position, carries the vehicle radially outwardly and lowers it onto the fixed comb of the designated bay before retracting to the inner ring 22. If it is desired, the vehicle may remain on the inner ring 22 and does not have to be transferred.

A vehicle is retrieved by the reverse of the procedure outlined above.

If desired the turntables can be omitted as shown in FIG. 6. Sufficient road space is then provided outwardly of the rotatable transfer ring to enable a driver to park his vehicle in one of a series of demarked bays 50 radially outwardly of the ring 12. The bays 50 can have markings, which can be illuminated to enable a driver to position his vehicle correctly. The base of each bay 50 is in the form of a fixed comb.

The bays 50 can be enclosed by gates for safety purposes and the dividers between the bays 50 and the bays 14 can be roller blinds onto which instructions can be projected. Once one of these blinds has rolled up, one of the movable combs 30 of the ring 12 moves outwardly, rises through the fixed comb, lifts the vehicle and carries it into a bay 14. Thereafter the parking procedure is as described above.

Whilst the structure is primarily intended as a parking garage for vehicles, it can be used to store shipping containers or palletized loads.

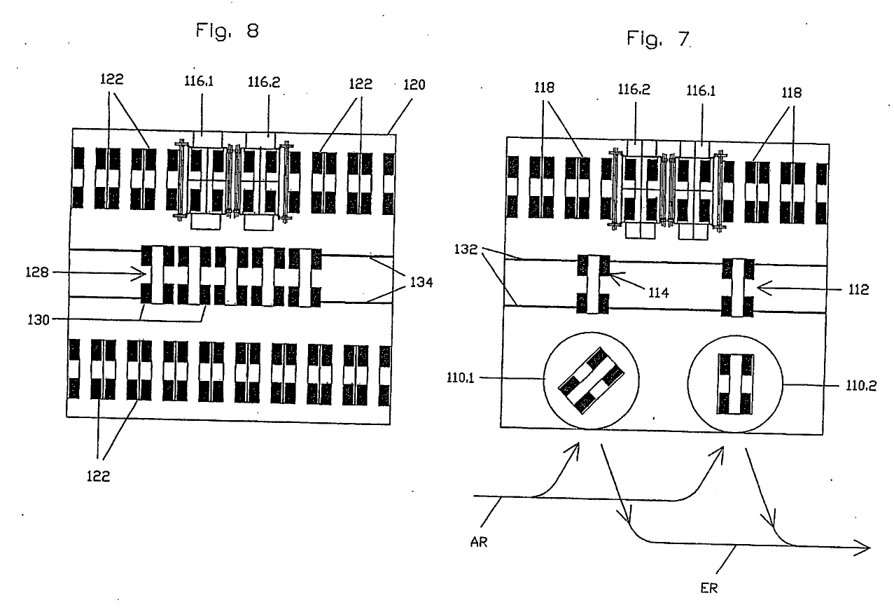

Referring now to FIG. 7, the vehicle parking garage is constructed on a rectangular format and includes entry and exit turntables. In the embodiment illustrated in FIGS. 7 and 8 there are two turntables designated 110.1 and 110.2. More than two turntables, preferably equally spaced apart, can be provided. The turntable 110.1 is shown in the position it adopts whilst a vehicle is being driven in. Turntable 110.2 is shown in the position it adopts to enable a vehicle to be transferred between the turntable and the left hand one of two reciprocable shuttles 112 and 114 which are alongside the turntables 110.1, 110.2. On the opposite side of the shuttles 112, 114 to the turntables there are two lifts (or elevators) 116.1, 116.2 and parking bays 118 outwardly of each lift 116.1, 116.2. In the illustrated embodiment there are three parking bays 118 outwardly of each lift.

The shuttle 112 moves back and forth between the intermediate position shown, in which it is aligned with the turntable 110.2, and two end positions in one of which it is aligned with the end bay 118 and in the other of which it is aligned with the lift 116.1. Similarly the shuttle 114 moves between the intermediate position shown, in which it is aligned with the turntable 110.1, and two end positions in one of which it is aligned with the lift 116.2 and in the other of which it is aligned with the other end bay 118. Each shuttle 112, 114 has a single vehicle bay.

The lifts 116.1, 116.2 are immediately adjacent one another and are as described above.

In FIG. 8, which shows the floor layout from the first floor upwards, there is a stationary structure 120 which provides two rows of parking bays 122 for vehicles. The lifts 116.1, 116.2 are also shown in FIG. 8 and pass upwardly through the structure 120.

Between the two rows of bays 122 there is a further reciprocable shuttle 128. The shuttle 128 comprises, in the illustrated form, five vehicle bays 130. The two end bays 130 are always required for use in parking and returning vehicles. The three middle bays 130 can, at least at some times, be used as parking bays.

The shuttles 112, 114 and 128 are carried on rollers or wheels (not shown) which run on rails 132, 134 (see FIGS. 7 and 8).

On entry level the floors of the turntables 110.1, 110.2 are constituted by fixed combs, the bays of the shuttles 112, 114 have floors constituted by movable combs, the lifts 116.1, 116.2 have floors constituted by fixed combs, and the bays 118 have floors constituted by fixed combs. On each parking level the bays 122 of the structure 120 have floors constituted by fixed combs and the floors of the bays 130 are constituted by movable combs. If a bay 130 is to be used as a parking bay then its floor comprises both a fixed and a movable comb. The fixed and movable combs are as described above and will not be described in detail herein.

It will be understood that the parking levels may be below the entry level instead of above it or there may be parking levels both above and below entry level.

A vehicle to be parked enters on the approach road and is directed by road markings and illuminated signs along the path designated AR onto a turntable which is positioned as turntable 110.1 is so that the vehicle can easily be driven onto the turntable. The vehicle is supported by the turntable=s fixed comb.

The turntables are in an enclosure having vehicle doors at each end of it and a pedestrian door to one side. At the time the vehicle is driven in, the vehicle door leading from the enclosure to the shuttle 114 is closed. It is also possible for the enclosure to have a door allowing entrance from the road AR and a further door allowing exit to the road ER.

Once the driver has locked the vehicle and left the enclosure via the pedestrian door, the vehicle door leading to the approach road and the pedestrian door close and the door leading to the shuttle opens.

The shuttle 114 moves to the position in which it is aligned with the turntable 110.1 and the turntable 110.1 rotates so that the vehicle=s nose is pointing in the direction of entry and its rear towards the shuttle. The turntable stops when it is the same position as the turntable 110.2. The movable comb of the shuttle 114 moves outwardly under the fixed comb of the turntable, rises thereby lifting the vehicle off the turntable, and carries it onto the shuttle 114.

The shuttle 114 then moves sideways until it is aligned with the lift 116.2. The movable comb lifts the vehicle, carries it into the lift 116.2 and then lowers it onto the fixed comb of the lift 116.2 before retracting into the shuttle 114. The lift 116.2 carries the vehicle to an upper (or lower) parking level where it is removed from the lift by one of the movable combs of the shuttle 128, moved sideways, and then carried by the movable comb on which it is supported into one of the parking bays 122.

If any one of the left hand group of three bays 118 is empty, the vehicle can be placed in that instead of being put in the lift.

The vehicle is returned to the owner by the reverse of the procedure described. The turntable with the returned vehicle on it is in a position at a convenient angle, which may be a right angle to the illustrated position of the turntable 110.1 so that the driver can easily drive off the turntable into the exit road ER.

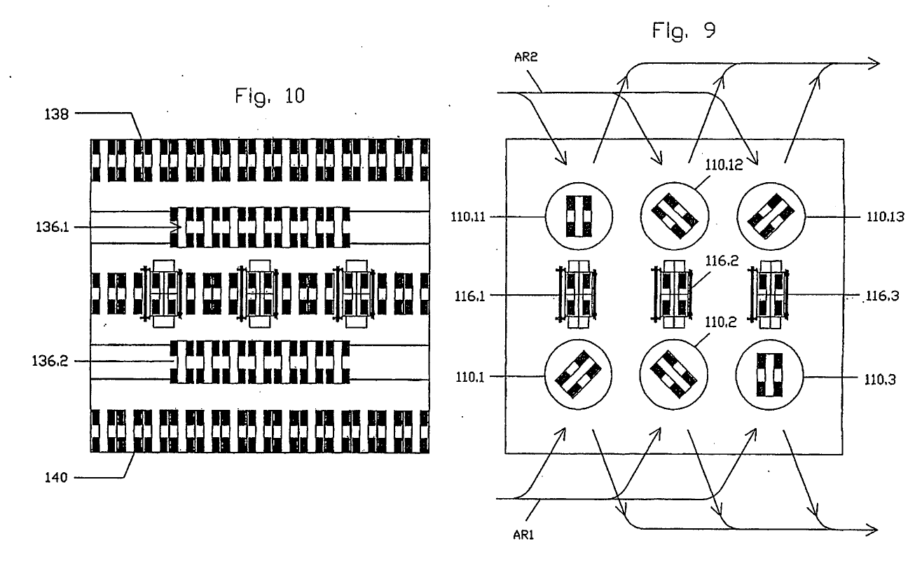

In FIGS. 9 and 10 a parking garage is shown in which there is vehicle access from two approach roads AR1 and AR2. The garage includes two sets of three turntables 110.1, 110.2, 110.3, 110.11, 110.12, 110.13 and three lifts 116.1, 116.2, 116.3. In the embodiment of FIGS. 9 and 10, at entry level, the movable combs form parts of the turntables.

At each parking level there are two shuttles 136.1, 136.2. The shuttles have movable combs for moving vehicles in and out of the lifts and in and out of the parking bays.

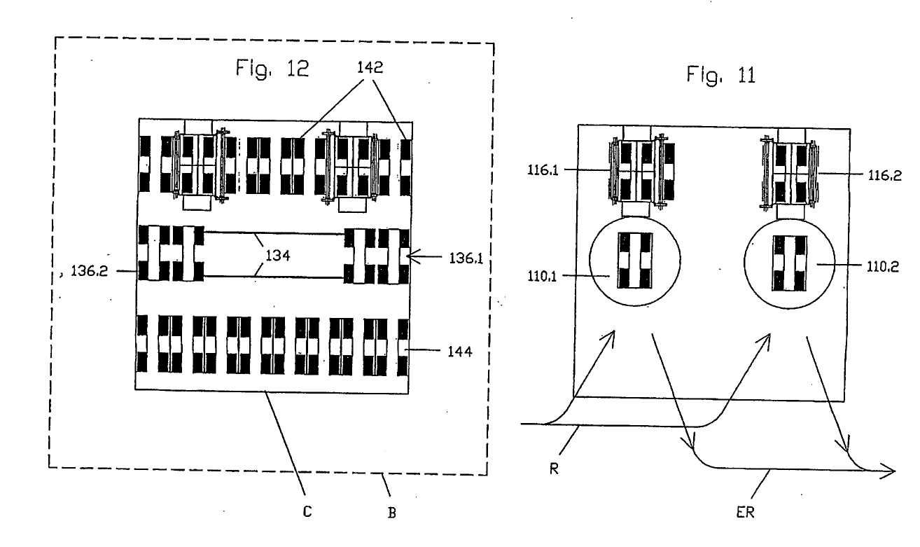

In FIGS. 11 and 12 a structure similar to that of FIGS. 9 and 10 is shown which is specifically intended for construction on a rectangular site smaller than that of FIGS. 9 and 10 and which has access from only one side. The same reference numerals are used in FIGS. 11 and 12 as are used in FIGS. 9 and 10. Two independently movable shuttles 136.1, 136.2 are provided at each parking level. The outer bays are used as transfer bays and the inner ones (ten per floor) are used as parking bays.

In FIGS. 9 to 12 the vehicles are transferred from the turntables to the lifts by movable combs of the lifts once the turntables and lifts are aligned. At the parking levels the combs of the lifts act as fixed combs and the movable combs of the shuttles 136.1, 136.2 remove the vehicles from the lifts. These movable combs also load the vehicles into and remove them from the rows of parking bays designated 138, 140 in FIG. 10 and 42, 44 in FIG. 12.

If the site is bigger than shown in FIG. 11 the structure of FIGS. 11 and 6 can form the core of a residential or office building. The outline of the core is shown by the line C in FIG. 12 and the outline of the building by the line B. Between the lines B and C there can be office space or residential apartments. The size of the office space or number of apartments is dependent on the size of the site and on the number of parking bays which are required in the core.

What is claimed is:

1. A storage system comprising:
two sets of endless elements with load supporting platforms attached thereto at intervals;
said lift having an operative run in which said platforms are horizontal and can support a load and an inoperative run in which said platforms are upright, said platforms being permanently connected to one set of endless elements and detachably connected to another set of endless elements; and,
objects at upper and lower ends of said lift for displacing said platforms between a horizontal, operative position in which said platforms are connected to both of said sets of elements and an inoperative, upright position in which said platforms are connected to one of said sets of elements only.

2. The system as claimed in claim 1, wherein each platform comprises a series of parallel spaced bars each of which is supported at one end only thereby to form a comb.

3. The system as claimed in claim 1, wherein each platform comprises two series of parallel bars, said bars of each series being supported at one end only thereby to form two combs, wherein free ends of said bars of said two combs facing one another across a gap.

4. The system as claimed in claim 1, wherein said one set of elements comprises a first pair of endless elements, said endless elements of said first pair being entrained around first pairs of upper wheels rotatable about a first common axis and lower wheels being rotatable about a second common axis parallel to said first common axis, there being objects configured to drive said upper or lower pairs of wheels and said platforms being pivotally and permanently connected to said first pair of endless elements, said other set of endless elements comprising a second pair of endless elements, said elements of said second pair being entrained around second pairs of upper and lower wheels, said upper wheels of said second pair being rotatable about a common third axis and said lower wheels of said second pair being rotatable about a common fourth axis, said third and fourth axes being parallel to one another, said platforms and said second pair of endless elements are configured to be releasably attached to one another whilst said platforms are in operative horizontal positions.

5. A storage system comprising:
at entry and exit level, a rotatable transfer ring including bays, each bay configured to support an article to be stored and a transport configured to transport articles between positions radially outwardly of said ring and positions within said bays, and between positions within said bays and positions radially inwardly of said ring;
at each storage level a rotatable inner ring including bays, each bay configured to support an article to be stored and wherein said transport is configured to transfer articles between positions radially outwardly of said inner ring and positions within said bays, and between positions within said bays and positions radially inwardly of said inner ring, and a stationary outer ring having bays for storing articles; and,
at least two lifts radially inwardly of said rotatable transfer and inner rings for conveying articles between said entry and exit level and at least one storage level.

6. The storage system as claimed in claim 5, wherein each bay of said outer ring at a storage level has a floor comprising a fixed comb of parallel bars supported at one end.

7. The storage system as claimed in claim 5, wherein each bay of said rotatable ring at a storage level comprise a fixed comb of parallel bars and a movable comb of parallel bars, said bars of said movable comb being able to pass through gaps between said bars of said fixed comb.

8. The storage system as claimed in claim 5, wherein turntables are provided at said entry and exit level to enable said article to be stored to be aligned with said bays of said rotatable transfer ring.

9. A storage system comprising a plurality of storage levels, there being lifts configured to bring articles to said storage levels and removing articles from said storage levels, said system further comprising, at each storage level, a reciprocable shuttle having bays for temporarily accommodating articles to be stored, storage bays for receiving articles to be stored, and an object carried by said shuttle wherein said object is configured to transfer articles between said lifts and said shuttle and between said bays and said shuttle.

10. The storage system as claimed in claim 9 further comprising turntables at an entry and exit level, each of said turntables being rotatable between a loading position and a position aligned with a lift for transfer of an article between said turntable and said lift.

11. The storage system as claimed in claim 10, wherein said turntables have a third position for unloading.

12. The storage system as claimed in claim 5, wherein each lift comprises two sets of endless elements with load supporting platforms attached thereto at intervals, each lift having an operative run in which said platforms are horizontal and can support a load and an inoperative run in which said platforms are upright, said platforms being permanently connected to one set of endless elements and detachably connected to another set of endless elements, and an object at said upper and lower ends of said lift configured to displace said platforms between a horizontal, operative position in which said platforms are connected to both of said sets of elements and an inoperative, upright position in which said platforms are connected to one of said sets of elements only.

13. The storage system as claimed in claim 12, wherein said one set of endless elements of each lift comprises a first pair of endless elements, said endless elements of said first pair being entrained around first pairs of upper wheels rotatable about a first common axis and said lower wheels being rotatable about a second common axis parallel to said first common axis, an object configured to drive said upper or lower pairs of wheels and said platforms being pivotally and permanently connected to said first pair of endless elements, another set of endless elements of each lift comprising a second pair of endless elements, said elements of said second pair being entrained around second pairs of upper and lower wheels, said upper wheels of said second pair rotatable about a common third axis and said lower wheels of said second pair rotating about a common fourth axis, said third and fourth axes being parallel to one another, and said platforms are configured to be attached to said second pair of endless elements whilst said platforms are in operative horizontal positions.
